(19) United States
(12) Patent Application Publication
(10) Pub. No.: US 2014/0176269 A1
(43) Pub. Date: Jun. 26, 2014

(54) DEVICE FOR TRACKED WHEEL WITH MAGNETIC BAND

(71) Applicant: Jorge Masia Perales, Valencia (ES)

(72) Inventor: Jorge Masia Perales, Valencia (ES)

(73) Assignee: ELIOT SYSTEMS, S.L., L'Alcudia, Valencia (ES)

(21) Appl. No.: 14/116,529

(22) PCT Filed: Jun. 6, 2012
(86) PCT No.: PCT/ES2012/070421

§ 371 Date: Nov. 8, 2013

(30) Foreign Application Priority Data
Jun. 16, 2011 (ES) P 201131015

(51) Int. Cl. H01F 7/02

(52) U.S. Cl. CPC H01F 7/0221
USPC 335/219

(57) ABSTRACT

Improved device (1) for a tracked wheel with magnetic band (5) that is characterized in that it comprises a cavity (2) accommodating a magnet (3), this cavity (2) being sufficiently deep to completely accommodate the magnet (3) and an element (4) for attaching the actual device (1) to the magnetic band (5) on which it is placed and where lateral ridges (6) of the device (1) are provided with rounded edges (7).

This invention relates to a device for attaching magnets in tracked wheels of robots with magnetic band that is specially designed for application in robots that work with metal surfaces.

### STATE OF THE PRIOR ART

Currently the magnetic band of the tracked wheels consists of the placing of magnets directly onto the same using screws or similar attaching elements.

The problem showing these magnetic bands is that when coming into contact with the metal surfaces produce scratches and damage the paint of the same.

### EXPLANATION OF THE INVENTION

The device of the present invention solves the problem set out above allowing the magnetic band of a robot to come into contact with a metal surface without damaging or scratching the paint of the surface.

The device of the invention has a cavity accommodating a magnet of the magnetic band. This cavity is sufficiently deep to completely contain the magnet and to completely accommodate the element for attaching the magnet to the device so as to avoid that when the device comes into contact with the metal surface, the magnet or attaching element come into contact with such metal surface. The device of the invention is designed so that the distance between the magnet and the metal surface with which it works, allows the magnet to effect the necessary attraction over the metal surface.

The device of the invention is ready to be attached to the magnetic band of the track. Screws can be used to secure the device to the magnetic band.

The requirement of geometry that the device must comply is that it must have rounded edges that are in the direction perpendicular to the direction of movement of the magnetic band.

The device is made of plastic. It may be plastic of the type of PVC, nylon, Teflon, etc. As the device is made of a plastic material, it does not damage the metal surface when comes in contact with it.

The magnet is attached to the device by means of a screw or a similar attaching means.

The device comes into contact with the metal surface avoiding the direct contact of the screw and magnet with said surface.

It is utilized one device for each magnet placed in the magnetic band of the track. These devices must be placed along the entire surface of the magnetic band.

Throughout the description and claims, the word “comprises” and its variations are not intended to exclude other technical features, additives, components or steps. For those skilled in the art, other objects, advantages and characteristics of the invention will emerge in part from the description and in part from the practice of the invention. The following examples and drawings are provided by way of illustration, and are not intended to be limiting of the present invention. Furthermore, the present invention covers all the possible combinations of particular and preferred embodiments herein indicated.

### BRIEF DESCRIPTION OF THE DRAWINGS

FIG. 1 shows the improved device for tracked wheel with magnetic band of the present invention.

FIG. 2 shows the assembly of the device of the invention with the magnet placed in it.

FIG. 3 shows a partial view of the magnetic band of the track with several devices installed on it.

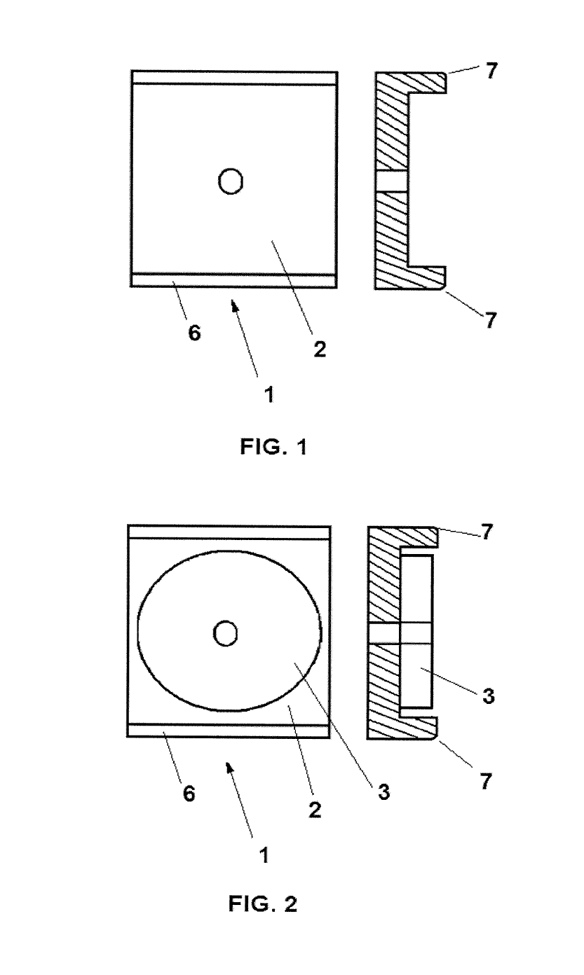

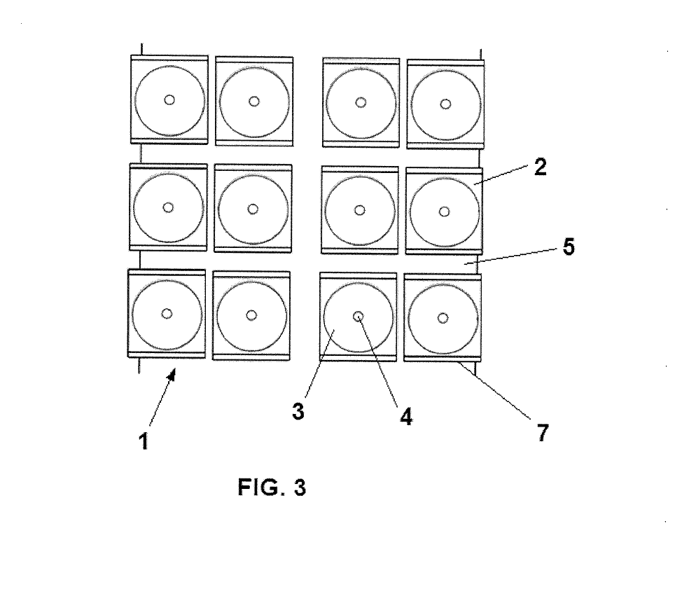

### REFERENCES

1: Device; 2: Cavity; 3: Magnet; 4: Attaching element; 5: Magnetic band; 6: Edges; 7: Rounded edges

### DETAILED DESCRIPTION OF EMBODIMENTS

The improved device (1) for tracked wheel with magnetic band (5) of the present invention is designed to be used particularly in robots with tracked wheel with magnetic band (5) that works on metal surfaces.

The aim of the present invention is to provide a device to avoid that the magnet (3) and the element (4) for attaching the magnet (3) to the device (1) and to the magnetic band (5) come into contact with the metal surface on which the robot works in which it is incorporated. Damage to the metal surface or scratching of the paint of said the surface is thus avoided. To that end the magnet comprises a cavity (2) accommodating the magnet (3), this cavity (2) being sufficiently deep to completely accommodate the magnet (3) and an attaching element (4) that attaches the magnet to the device (1) and this to the magnetic band (5) leaving a gap between the upper surface of the magnet (3) and attaching element (4) and the upper surface of the device (1). The edges of the devices that are perpendicular to the direction of the movement of the magnetic band (5) are provided with rounded edges (7) in order to facilitate the contact with the metal surface when the tracked wheel moves.

The device (1) is made of a plastic material. Such plastic material may be PVC, nylon, etc. Since it is of plastic material, it does not damage the metal surface when comes into contact with it nor causes scratches in the paint of said surface.

1. Improved device (1) for tracked wheel with magnetic band (5) that is characterized in that it comprises a cavity (2) accommodating a magnet (3), this cavity (2) being sufficiently deep to completely accommodate the magnet (3) and a attaching element (4) of the magnet (3) to the actual device (1) and the magnetic band (5) on which it is placed the device (1) leaving a gap between the upper surfaces of the magnet (3) and attaching element (4) and the upper surface of the device (1) avoiding that the magnet (3) and attaching element (4) come into contact with a metal surface on which the device moves, and at least the edges (6) of the device (1) that are perpendicular to the direction of movement of the magnetic band (5) are provided with rounded edges (7).

2. Device according to claim 1 that is made of a plastic material.
